(19) United States
(12) Patent Application Publication
(10) Pub. No.: US 2023/0115192 A1
(43) Pub. Date: Apr. 13, 2023

(54) Method And Apparatus For Enhancing Coexistence With Devices With Restricted RF Bandwidth

(71) Applicant: MediaTek Singapore Pte. Ltd., Singapore (SG)

(72) Inventors: Jozsef Gabor Nemeth, Cambridge (GB); Mohammed S Aleabe Al-Imari, Cambridge (GB)

(21) Appl. No.: 17/902,992

(22) Filed: Sep. 5, 2022

Related U.S. Application Data
(60) Provisional application No. 63/248,596, filed on Sep. 27, 2021.

(51) Int. Cl. H04W 16/14; H04W 56/00; H04W 24/10; H04L 27/26

(52) U.S. Cl. CPC H04W 16/14; H04L 27/26025; H04W 24/10; H04W 56/001

(57) ABSTRACT

An apparatus, implementable in a user equipment (UE), initiates any of an initial access procedure, a master information block (MIB)-decoding procedure or a measurement procedure with a wireless network. The apparatus also performs wireless communications with the wireless network upon completion of the initial access procedure, the MIB-decoding procedure or the measurement procedure. Each of the initial access procedure and the MlB-decoding procedure involves performing one or more operations enhancing coexistence of at least one reduced-capability (RedCap) UE having a restricted radio frequency (RF) bandwidth with at least one non-RedCap UE. The measurement procedure involves reporting to a serving cell of the wireless network about an outcome of one or more measurements performed on synchronization signals from both the service cell and a neighboring cell.

### CROSS REFERENCE TO RELATED PATENT APPLICATION(S

The present disclosure is part of a non-provisional application claiming the priority benefit of U.S. Pat. Application No. 63/248,596, filed 27 Sep. 2021, the content of which herein being incorporated by reference in its entirety.

### TECHNICAL FIELD

The present disclosure is generally related to mobile communications and, more particularly, to enhancements for coexistence with devices with a restricted radio frequency (RF) bandwidth plus measurements and synchronization in separate bandwidth parts (BWPs) in mobile communications.

### BACKGROUND

Unless otherwise indicated herein, approaches described in this section are not prior art to the claims listed below and are not admitted as prior art by inclusion in this section.

In Release 17 (Rel-17) of the 3^{rd} Generation Partnership Project (3GPP) standard for 5^{th} Generation (5G) New Radio (NR) mobile communications, reduced-capability (RedCap) device type(s) is a study item that targets enabling low-end application scenarios by trade-off in performance for lower user equipment (UE) complexity, power consumption, and form factor. For RedCap UE devices (or RedCap UEs) operating in Frequency Range 1 (FR1), the maximum UE bandwidth is 20 MHz for any RedCap UE. This requirement is reduced from a minimum of 100 MHz for non-RedCap NR UE devices. A further category of 5 MHz maximum bandwidth RedCap UE devices may need to be supported as well. Downlink (DL) and uplink (UL) bandwidth part (BWP) cannot be wider than the aforementioned maximum RF bandwidth of the RedCap UEs.

However, coexistence between RedCap UEs and non-RedCap UEs requires configuration of separate BWPs. Configuration of additional non-cell-defining (non-CD) synchronization signal block (SSB) is required to support a large number of RedCap UEs (e.g., low-end phones) and offload them to sub-bands. Non-CD SSBs may be used to conduct RRM measurements (of serving and neighbor cells) and frequency/time tracking by a UE. The overhead issue is exacerbated if additional SSB(s) needs to be configured in more than just one BWP (e.g., to spread the network load and/or benefit from frequency diversity). For example, with eight sub-bands, the overhead tends to become rather significant. Moreover, 5 MHz DL BWP configured for paging may make the non-CD SSB overhead more relevant. If RedCap UEs with only 5 MHz maximum RF bandwidth are supported in FR1, then such RedCap UEs would not be able to decode the PBCH in case of 30 kHz subcarrier spacing (SCS), since 50% of PBCH bits would be punctured on the frequency edges. One approach to address this issue may be to apply SCS = 15 kHz numerology for at least SSB, CORESET #0, and SIB1. However, this approach could be overly restrictive and does not match currently existing deployments. Besides, any alternative solution needs to be backward compatible.

Therefore, there is a need for a solution of enhancements for coexistence with RedCap UEs with a restricted RF bandwidth plus measurements and synchronization in separate BWPs in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving enhancements for coexistence with RedCap UEs with a restricted RF bandwidth plus measurements and synchronization in separate BWPs in mobile communications.

In one aspect, a method may involve initiating either an initial access procedure or a master information block (MIB)-decoding procedure with a wireless network. The method may also involve performing wireless communications with the wireless network upon completion of the initial access procedure or the MIB-decoding procedure. The MIB-decoding procedure may involve receiving an MIB during paging or system information reception. Each of the initial access procedure and the MIB-decoding procedure may involve performing one or more operations enhancing coexistence of at least one RedCap UE having a restricted RF bandwidth with at least one non-RedCap UE. The one or more operations may include either or both of: (i) receiving signaling from the wireless network; and (ii) transmitting a report to the wireless network.

In another aspect, a method may involve initiating either an initial access procedure or a measurement procedure with a wireless network. The measurement procedure may involve reporting to a serving cell of the wireless network about an outcome of one or more measurements performed on synchronization signals from both the service cell and a neighboring cell. The method may also involve performing wireless communications with the wireless network upon completion of the initial access procedure or the measurement procedure. The wireless communications may involve receiving a DL BWP configuration for RedCap UEs, but not for non-RedCap UEs, configured with a special, non-cell-defining SSB that does not contain any physical broadcast channel (PBCH). Alternatively, or additionally, the wireless communications may involve receiving a configuration or an indication of activation of downlink-uplink (DL-UL) BWP pairs with different center frequencies in time-division duplex (TDD) with a gap of N symbols for RF retuning after DL reception, UL transmission or both, with N being a positive integer.

In yet another aspect, a method may involve initiating either an initial access procedure or a measurement procedure with a wireless network. The measurement procedure may involve reporting to a serving cell of the wireless network about an outcome of one or more measurements performed on synchronization signals from both the service cell and a neighboring cell. The method may also involve performing wireless communications with the wireless network upon completion of the initial access procedure or the measurement procedure. In this method, frequency hopping of a BWP center frequency may be supported. Moreover, radio resource management (RRM) report format options may include separate measurements for each BWP center frequency index.

In still another aspect, an apparatus may include a transceiver and a processor coupled to the transceiver. The transceiver may be configured to communicate wirelessly. The processor may initiate, via the transceiver, any of an initial access procedure, an MIB-decoding procedure or a measurement procedure with a wireless network. The processor may also perform, via the transceiver, wireless communications with wireless network cell upon completion of the initial access procedure, the MIB-decoding procedure or the measurement procedure. The MIB-decoding procedure may involve receiving an MIB during paging or system information reception. The measurement procedure may involve reporting to a serving cell of the wireless network about an outcome of one or more measurements performed on synchronization signals from both the service cell and a neighboring cell. Each of the initial access procedure and the MIB-decoding procedure may involve performing one or more operations enhancing coexistence of at least one RedCap UE having a restricted RF bandwidth with at least one non-RedCap UE. The one or more operations may include either or both of: (i) receiving signaling from the wireless network; and (ii) transmitting a report to the wireless network.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-loT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example scenario under a proposed scheme in accordance with the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements for coexistence with RedCap UEs with a restricted RF bandwidth plus measurements and synchronization in separate BWPs in mobile communications. According to the present disclosure, a number of possible solutions may be implemented separately or jointly. That is, although these possible solutions may be described below separately, two or more of these possible solutions may be implemented in one combination or another.

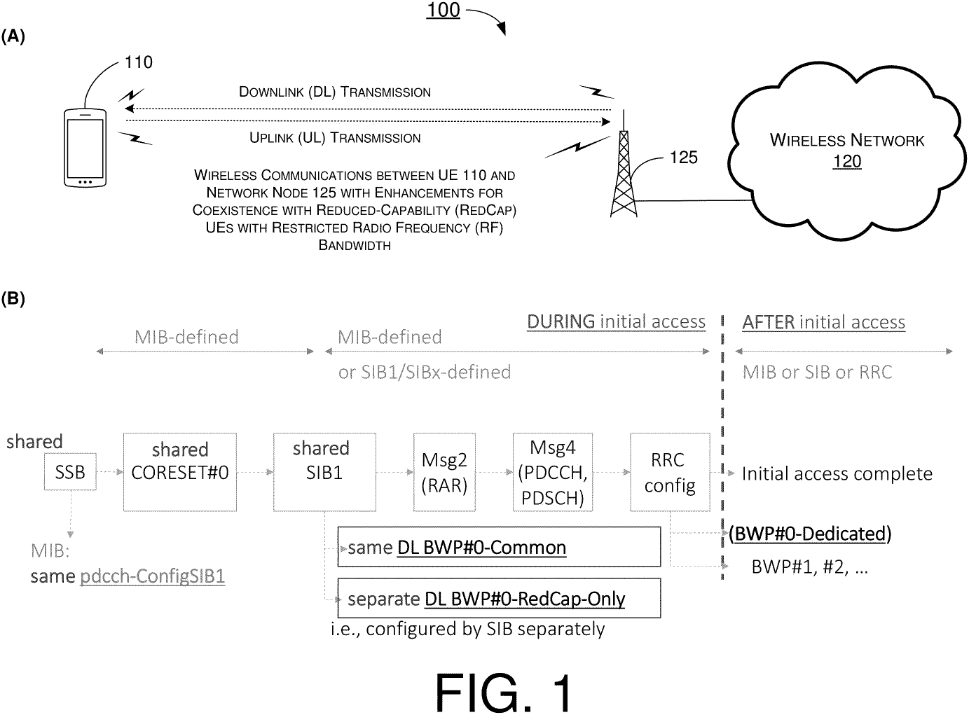

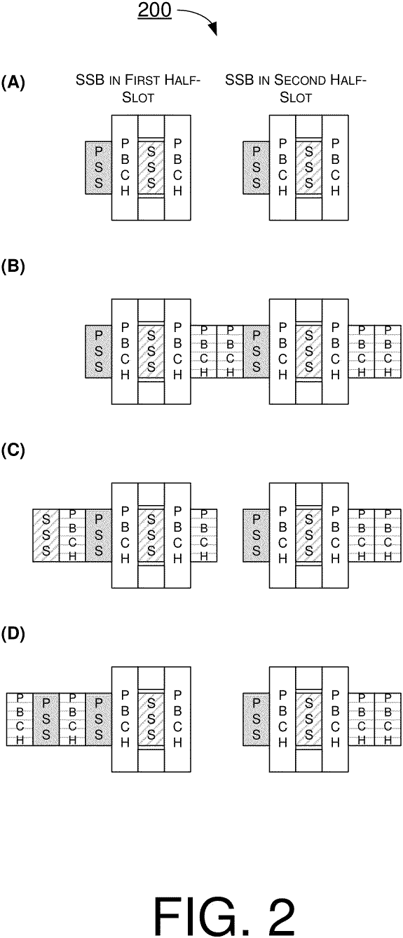

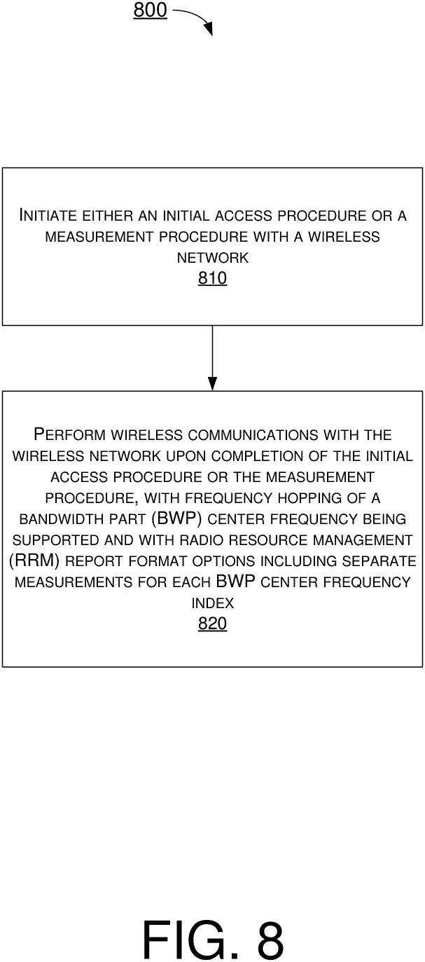

FIG. 1 illustrates an example network environment 100 in which various solutions and schemes in accordance with the present disclosure may be implemented. FIG. 2 ~ FIG. 8 illustrate examples of implementation of various proposed schemes in network environment 100 in accordance with the present disclosure. The following description of various proposed schemes is provided with reference to FIG. 1 ~ FIG. 8. Referring to part (A) of FIG. 1, network environment 100 may involve a UE 110 in wireless communication with a wireless network 120 (e.g., a 5G NR mobile network or another type of network such as an NTN). UE 110 may be in wireless communication with wireless network 120 via a base station or network node 125 (e.g., an eNB, gNB or transmit-receive point (TRP)). In network environment 100, UE 110 and wireless network 120 (via network node 125) may implement various schemes pertaining to enhancements for coexistence with RedCap UEs with a restricted RF bandwidth plus measurements and synchronization in separate BWPs in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

The assumptions on the Rel-17 standard BWP configuration are summarized below with reference to part (B) of FIG. 1. During an initial access procedure (for a UE to establish access to a cell and its associated wireless network), after detecting the cell-defining synchronization signal (SS) and physical broadcast channel (PBCH) block (CD-SSB) shared between RedCap and non-RedCap UEs, the PBCH is decoded to obtain the master information block (MIB). This would specify the resource and search space for control resource set (CORESET) #0 and scheduling information for system information block 1 (SIB1). In SIB1 either the same or separate initial DL BWP and/or UL BWP are configured for RedCap UEs and non-RedCap UEs. They are used in a random access channel (RACH) procedure and after the radio resource control (RRC) configurations are complete, including the configuration of other BWPs.

In terms of initial synchronization procedure versus radio resource management (RRM) measurement, non-coherent primary synchronization signal (PSS) detection and coarse carrier frequency offset (CFO) estimation may be performed simultaneously for all time offsets within a 20-ms period, simultaneously for three sequences, simultaneously for different coarse CFO hypotheses, simultaneously to update moving average for 10- or 20-ms periodicity, and/or simultaneously for each beam in an SSB burst of 2-to-5 ms. As for coherent secondary synchronization signal (SSS), detection may be based on timing channel and CFO estimates from PSS detection. It may be performed simultaneously for 336 different candidate sequences or for just a single (or a few) time-frequency location(s). Moreover, PBCH decoding may be performed using SSS for channel/noise/Doppler estimation in addition to demodulation reference signal (DMRS), with the same numerology required.

With respect to measurement objects, a network may configure a UE to report certain measurement information based on SS/PBCH block(s) (herein interchangeably referred to as “SSB(s)”), such as: measurement results per SS/PBCH block, measurement results per cell based on SS/PBCH block(s), and SS/PBCH block(s) indexes. For intra-frequency and inter-frequency measurements, a measurement object indicates the frequency/time location and subcarrier spacing of reference signals to be measured. Associated with this measurement object, the network may configure a list of cell specific offsets, a list of ‘blacklisted’ cells and a list ‘whitelisted’ cells. Blacklisted cells are not applicable in an event of evaluation or measurement reporting. Whitelisted cells are the only ones applicable in an event of evaluation or measurement reporting. Reporting configurations may include reporting criterion, reference signal (RS) type, and reporting format (e.g., maximum cells and maximum beams). Measurement identify links one measurement object with one reporting configuration (e.g., 1:n or m:1 or m:n mapping). Quantity configuration (QC) may include maximum of two per measurement object. In each QC, different filter coefficients may be configured for different measurement quantities, for different RS types, and for measurements per cell and per beam. Measurement gaps may refer to periods that the UE may use to perform measurements.

Under a first proposed scheme in accordance with the present disclosure with respect to matching PBCH bandwidth to 5 MHz UE bandwidth, cells admitting RedCap UEs with 5 MHz maximum RF bandwidth in FR1 may apply SS/PBCH block configuration or enhanced signaling that allow decoding of the PBCH by the RedCap UEs without RF returning between multiple attempts.

In a first approach under the proposed scheme, cell-level configurations may be restricted to SCS = 15 kHz for SSB, CORESET #0 and SIB1. For instance, initial DL BWP configurations indicated for RedCap UEs only by SIB (including numerology) may be applied during a RACH procedure and onwards. Alternatively, or additionally, initial DL BWP configurations indicated for RedCap UEs only by SIB (including numerology) may be applied after initial access only (e.g., after RRC configuration).

In a second approach under the proposed scheme, when SS/PBCH is transmitted with SCS = 30 kHz, then [n] orthogonal frequency-division multiplexing (OFDM) symbols occupying he central 12 physical resource blocks (PRBs) may be appended or prepended (in a predetermined pattern) to the legacy SSB block, which may repeat the encoded bits mapped onto the 4+4 PRBs on the frequency edges falling outside the UE bandwidth. This may be payload or exact same resource elements (REs) being repeated, regardless of whether the same cyclic redundancy check (CRC) is used. For instance, n = 2 and the additional OFDM symbols may be always appended after the legacy SSB. Alternatively, or additionally, n ≥ 2 and the additional OFDM symbols may be either appended or prepended to the legacy SSB depending on its position within the SSB burst structure. The coding rate and/or DMRS ratio may differ from the parameters of the legacy PBCH.

FIG. 2 illustrates an example scenario 200 under the first proposed scheme in accordance with the present disclosure. Specifically, scenario 200 shows examples of backward compatibility by preserving legacy SSB block. Part (A) of FIG. 2 shows an example of an original SSB in a first half-slot and a second half-slot. Part (B) of FIG. 2 shows an example of appending data symbols only, with identical patterns in each half-slot. Part (C) of FIG. 2 shows an example of appending data symbols and synchronization symbols, with different patterns in each half-slot. Part (D) of FIG. 2 shows an example of a gap being preserved and no gap being preserved.

In a third approach under the proposed scheme, separate cell-defining (CD) SSBs, CORESET #0s, SIB1 and dedicated RACH occasions (ROs) may be configured or transmitted for RedCap UEs only. The RedCap dedicated SSB may apply either signaling method in the first and second approaches described above to ensure that the reception falls within the UE’s bandwidth. SIB1 may signal the CD-SSB global synchronization channel number (GSCN) and MIB intended for non-RedCap UEs in case that a non-RedCap UE synchronizes to the CD-SSB separately configured for RedCap UEs. That information alone may be sufficient for RedCap UEs to receive SIB1 in an event that the configurations allow doing so. Optionally, SIB1 may contain a subset of SIB1 information. In some cases, the GSCN may be indicated through the same method as defined in the current 3GPP standard for the cases of non-CD SSB payload. In the third approach, SSB-to-RO mapping may be applied separately on RedCap and non-RedCap resources (e.g., separate CD-SSB burst sets and separate RO configurations). CORESET #0 may be configured with a common search space (CSS) associated with RACH. In some cases, a separate CORESET #0 may be configured with CSS associated with Open System Interconnection (OSI). Alternatively, or additionally, the separate CORESET #0 may be configured with CSS associated with paging and short messaging. Alternatively, or additionally, CORESET #0s configured for RedCap and non-RedCap UEs may not be allowed to overlap. Alternatively, or additionally, multiple separate initial BWPs may be configured via SIB and a selection procedure or via RRC, and such BWPs may be configured with non-CD SSB and CSS associated with RACH/paging/OSI.

Under a second proposed scheme in accordance with the present disclosure with respect to reduced overhead synchronization signaling block, when a DL BWP is configured for RedCap UEs only, such DL BWP may be configured with a special, non-CD SSB that does not contain any PCH symbols/PRBs. It is noteworthy that omitting the PBCH may represent reduced resource overhead for the network. The overhead-reduced (OHR) SSB may still be used for RRM measurement (of a serving cell and neighboring cells) and frequency/time tracking. In MeasurementObject, the definition of RS type may be extended by the enhanced SSB formats proposed herein.

In a first approach under the proposed scheme, the method may be used in conjunction with separate initial DL BWP configured for RedCap UEs only via SIB. In this case, the BWP may be at least configured with CSS associated with RACH and may be configured with CSS associated with paging. For instance, RACH opportunities may be all dedicated to RedCap UEs using such DL BWP and OHR-SSB burst set may be predefined/SIB-configurable and may differ from that of the legacy SSB burst set. SSB-to-RO mapping rules may be applied separately for RedCap UEs and non-RedCap UEs. In some cases, the OHR-SSB burst set may be more compact in duration than that of a legacy burst set. Moreover, some or all RACH opportunities may be shared between RedCap and non-RedCap UEs. The structure of the OHR-SSB burst set may be equivalent to that of a legacy SSB burst set structure with respect to SSB-to-RO mapping.

In a second approach under the proposed scheme, the structure of PSS and SSS symbols within an OHR-SSB block may be defined or otherwise SIB-configurable. It may minimize false alarm for other non-RedCap UEs performing cell reselection. In some cases, a single SSS symbol or two SSS symbols back-to-back may be transmitted, and only whitelisted cells may be measured. Alternatively, or additionally, one PSS and one or two SSS symbols may be transmitted back-to-back. Alternatively, or additionally, in FR1, the precoder may alternate between two beams on each symbol and SSBs between the two beams may be interlaced. The individual SSB may follow either of the patterns described above.

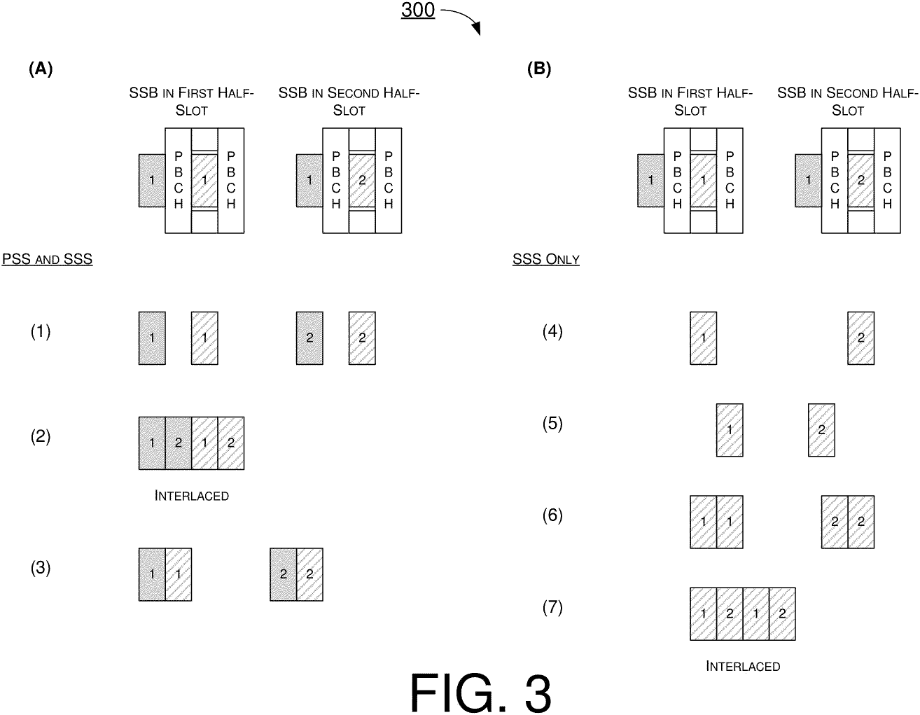

FIG. 3 illustrates an example scenario 300 under the second proposed scheme in accordance with the present disclosure. Specifically, scenario 300 shows examples of configurations of overhead-reduced synchronization signaling block. Part (A) of FIG. 3 shows three examples - examples (1), (2) and (3) - of overhead reduction when both PSS and SSS are transmitted. Part (B) of FIG. 3 shows four examples - examples (4), (5), (6) and (7) - of overhead reduction when only SSS is transmitted.

Under a third proposed scheme in accordance with the present disclosure with respect to DL/UL BWP pair with different center frequencies, in a first approach, configurations of DL-UL BWP-pairs with different center frequencies may be supported in time-division duplexing (TDD). Moreover, duration of [N] symbol gaps for RF retuning after DL reception and/or UL transmission may be allowed. Here, [N] may be defined in the numerology to which a UE is switching. For instance, the numerologies may not differ (e.g., [N] = 2). As a first option, UE processing timelines may be extended by the duration of the gap. As a second option, UE processing timeline overlap with the duration of the gap as well as the minimum of the two durations may be taken as an effective gap for the RF retuning.

In a second approach under the proposed scheme, the configuration of sounding reference signal (SRS) measurements falling outside of the UL BWP of RedCap UEs may be supported, at least in TDD. For UL-UL collision handling, the SRS measurement duration may be extended by a preceding and following gap of [N] symbols necessary for RF retuning.

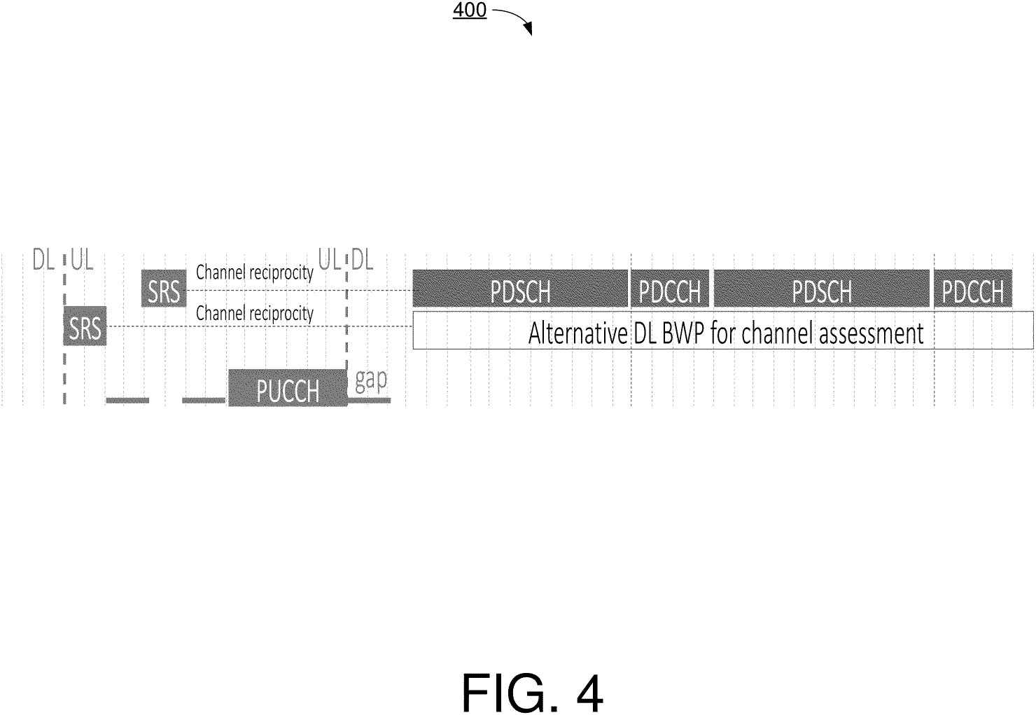

FIG. 4 illustrates an example scenario 400 under the third proposed scheme in accordance with the present disclosure. Specifically, scenario 400 shows examples of SRS measurements under this proposed scheme. For instance, UE 110 may transmit SRS outside the UL BWP of RedCap UEs for network node 125 to perform SRS measurements. To avoid UL-UL collision, the SRS measurement duration may be extended by a preceding gap and a following gap, each having a duration of [N] symbols, for RF retuning.

Under a fourth proposed scheme in accordance with the present disclosure with respect to measurement reports, certain operations may be performed in an event that frequency hopping of the BWP center frequency is supported and that the UE (e.g., UE 110) is operating using the frequency hopping mode. For instance, RRM report format options may also include separate measurement(s) per BWP center frequency index (e.g., separate measurement(s) for each BWP center frequency index). For each MeasurementObject, an attribute may select the DL BWP center frequency index (or indices) for which the MeasurementObject is configured. In such cases, frequency and/or time parameters of the configured measurement resources may be relative indices. In some implementations, that attribute may be represented by a bitmap where each bit corresponds to a frequency hop, with a value of “1” representing ‘measurementObject enabled’ and a value of “0” representing ‘measurementObject disabled’, or vice versa.

### Illustrative Implementations

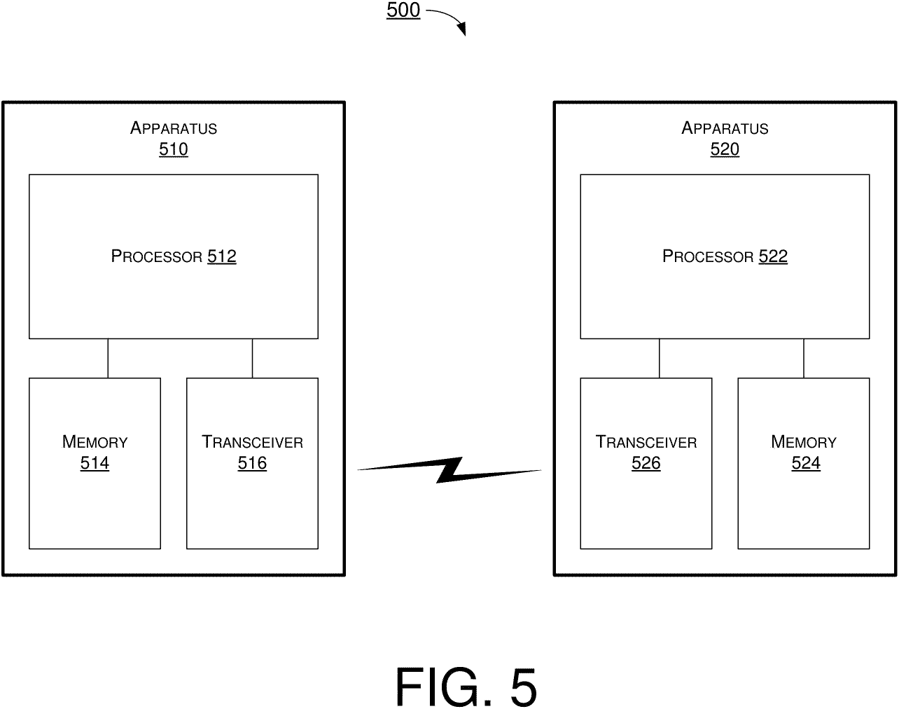

FIG. 5 illustrates an example communication system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to enhancements for coexistence with RedCap UEs with a restricted RF bandwidth plus measurements and synchronization in separate BWPs in mobile communications, including the various schemes described above with respect to various proposed designs, concepts, schemes, systems and methods described above, including network environment 100, as well as processes described below.

Each of apparatus 510 and apparatus 520 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 510 and apparatus 520 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 510 and apparatus 520 may also be a part of a machine type apparatus, which may be an loT apparatus such as an immobile or a stationary apparatus, a home apparatus, a roadside unit (RSU), a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in an eNodeB in an LTE, LTE-Advanced or LTE-Advanced Pro network or in a gNB or TRP in a 5G network, an NR network or an loT network.

In some implementations, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 510 and apparatus 520 may be implemented in or as a network apparatus or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to enhancements for coexistence with RedCap UEs with a restricted RF bandwidth plus measurements and synchronization in separate BWPs in mobile communications in accordance with various implementations of the present disclosure.

In some implementations, apparatus 510 may also include a transceiver 516 coupled to processor 512. Transceiver 516 may be capable of wirelessly transmitting and receiving data. In some implementations, transceiver 516 may be capable of wirelessly communicating with different types of wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510, as a UE (e.g., UE 110), and apparatus 520, as a network node (e.g., network node 125) of a wireless network (e.g., network 120 as a 5G/NR mobile network), is provided below.

Under various proposed schemes in accordance with the present disclosure pertaining to enhancements for coexistence with RedCap UEs with a restricted RF bandwidth plus measurements and synchronization in separate BWPs in mobile communications, processor 512 of apparatus 510, implemented in or as UE 110, may initiate, via transceiver 516, either an initial access procedure or a MIB-decoding procedure with a wireless network (e.g., a cell associated with apparatus 520 as network node 125 of wireless network 120). The MIB-decoding procedure may involve receiving an MIB during paging or system information reception. Each of the initial access procedure and the MIB-decoding procedure may involve performing one or more operations enhancing coexistence of at least one RedCap UE having a restricted RF bandwidth (e.g., 5 MHz) with at least one non-RedCap UE. Such one or more operations may involve receiving signaling from the wireless network and/or transmitting a report to the wireless network. Moreover, processor 512 may perform, via transceiver 516, wireless communications with the wireless network upon completion of the initial access procedure or the MIB-decoding procedure.

In some implementations, in performing the wireless communications, processor 512 may receive an SSB (e.g., a SS/PBCH block) configuration or an enhanced signaling that allows decoding of a PBCH by the at least one RedCap UE without RF retuning between multiple attempts. In some implementations, cell-level configurations may be restricted to SCS = 15 kHz for SSB, CORESET #0, and SIB1. In some implementations, an initial DL BWP configuration indicated for RedCap UEs, but not for non-RedCap UEs, by a SIB may be applied during a RACH procedure and onwards. Alternatively, or additionally, the initial DL BWP configuration indicated for RedCap UEs, but not for non-RedCap UEs, by the SIB may be applied after the initial access procedure.

In some implementations, in performing the wireless communications, processor 512 may receive an SSB with a SCS = 30 kHz. In some implementations, the SSB may include a predetermined number (n) of OFDM symbols occupying multiple central PRBs being appended or prepended to a legacy SSB. In some implementations, n = 2, and in such cases the OFDM symbols may be appended after the legacy SSB. In some implementations, n ≥ 2, and in such cases the OFDM symbols may be appended or prepended to the legacy SSB depending on a position of the legacy SSB within a SSB burst structure.

Under various proposed schemes in accordance with the present disclosure pertaining to enhancements for coexistence with RedCap UEs with a restricted RF bandwidth plus measurements and synchronization in separate BWPs in mobile communications, processor 512 of apparatus 510, implemented in or as UE 110, may initiate, via transceiver 516, either an initial access procedure or a measurement procedure with a wireless network (e.g., a cell associated with apparatus 520 as network node 125 of wireless network 120). The measurement procedure may involve processor 512 reporting to a serving cell of the wireless network about an outcome of one or more measurements performed on synchronization signals from both the service cell and a neighboring cell. Moreover, processor 512 may perform, via transceiver 516, wireless communications with the wireless network upon completion of the initial access procedure or the measurement procedure. The wireless communications may involve receiving a DL BWP configuration for RedCap UEs, but not for non-RedCap UEs, configured with a special, non-cell-defining SSB that does not contain any PBCH. Alternatively, the wireless communications may involve receiving a configuration or an indication of activation of DL-UL BWP pairs with different center frequencies in TDD with a gap of N symbols for RF retuning after DL reception, UL transmission or both, with N being a positive integer.

In some implementations, the DL BWP configuration may be indicated via an SIB and may also be configured with a CSS associated with a RACH and with another CSS associated with paging.

In some implementations, the DL BWP configuration may be configured with a CSS associated with a RACH and with another CSS associated with paging. In some implementations, in addition to receiving the DL BWP configuration, processor 512 may perform additional operations. For instance, processor 512 may receive a single SSS symbol or two SSS symbols back-to-back. Alternatively, processor 512 may receive one PSS symbol and one or two SSS symbols back-to-back.

In some implementations, responsive to receiving the indication of activation of the DL-UL BWP pairs, either: (i) UE processing timelines may be extended by a duration of the gap; or (ii) the UE processing timelines may overlap with the duration of the gap, with a minimum between a duration of the UE processing timelines and the duration of the gap being taken as an effective gap for the RF retuning. In some implementations, responsive to receiving the configuration of the DL-UL BWP pairs, a configuration of SRS measurements falling outside of a UL BWP of the at least one RedCap UE is supported at least in TDD.

Under various proposed schemes in accordance with the present disclosure pertaining to enhancements for coexistence with RedCap UEs with a restricted RF bandwidth plus measurements and synchronization in separate BWPs in mobile communications, processor 512 of apparatus 510, implemented in or as UE 110, may initiate, via transceiver 516, either an initial access procedure or a measurement procedure with a wireless network (e.g., a cell associated with apparatus 520 as network node 125 of wireless network 120). The measurement procedure may involve processor 512 reporting to a serving cell of the wireless network about an outcome of one or more measurements performed on synchronization signals from both the service cell and a neighboring cell. Moreover, processor 512 may perform, via transceiver 516, wireless communications with the wireless network upon completion of the initial access procedure or the measurement procedure. In some implementations, frequency hopping of a BWP center frequency may be supported. Moreover, RRM report format options may include separate measurements for each BWP center frequency index.

In some implementations, frequency hopping of a BWP center frequency may be supported. In such cases, RRM report format options may include separate measurements for each BWP center frequency index. In some implementations, for each measurement object, an attribute may select a DL BWP center frequency index for which the measurement object is configured. In some implementations, the attribute may include a bitmap with each bit of the bitmap corresponding to a respective frequency hop, with a first value of each bit (e.g., 1) representing the measurement object being enabled and a second value of each bit (e.g., 0) representing the measurement object being disabled.

### Illustrative Processes

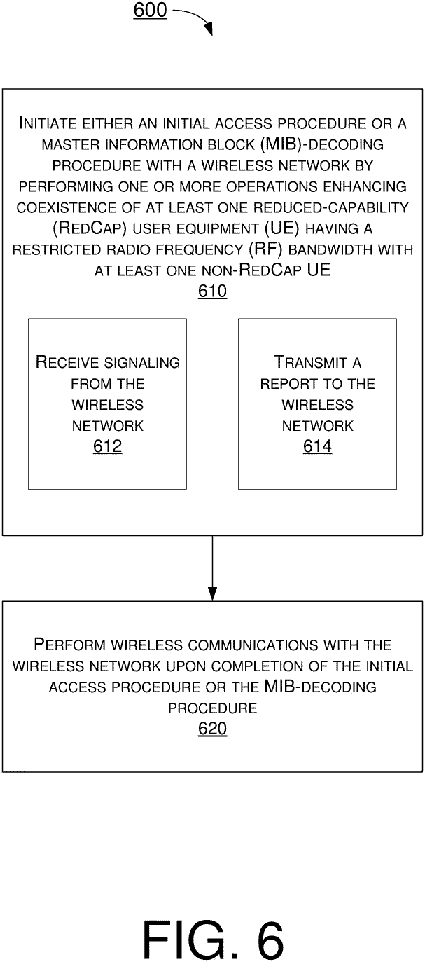

FIG. 6 illustrates an example process 600 in accordance with an implementation of the present disclosure. Process 600 may represent an aspect of implementing various proposed designs, concepts, schemes, systems and methods described above, whether partially or entirely, including those pertaining to those described above. More specifically, process 600 may represent an aspect of the proposed concepts and schemes pertaining to enhancements for coexistence with RedCap UEs with a restricted RF bandwidth plus measurements and synchronization in separate BWPs in mobile communications. Process 600 may include one or more operations, actions, or functions as illustrated by one or more of blocks 610 and 620 as well as subblocks 612 and 614. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 510 and apparatus 520 as well as any variations thereof. Solely for illustrative purposes and without limiting the scope, process 600 is described below in the context of apparatus 510 as a UE (e.g., UE 110) and apparatus 520 as a communication entity such as a network node or base station (e.g., network node 125) of a wireless network (e.g., wireless network 120). Process 600 may begin at block 610.

At 610, process 600 may involve processor 512 of apparatus 510 initiating, via transceiver 516, either an initial access procedure or a MIB-decoding procedure with a wireless network (e.g., a cell associated with apparatus 520 as network node 125 of wireless network 120). The MIB-decoding procedure may involve receiving an MIB during paging or system information reception. Each of the initial access procedure and the MIB-decoding procedure may involve performing one or more operations enhancing coexistence of at least one RedCap UE having a restricted RF bandwidth (e.g., 5 MHz) with at least one non-RedCap UE. The one or more operations may be represented by 612 and/or 614. Process 600 may proceed from 610 to 620.

At 620, process 600 may involve processor 512 performing, via transceiver 516, wireless communications with the wireless network upon completion of the initial access procedure or the MIB-decoding procedure.

At 612, process 600 may involve processor 512 receiving signaling from the wireless network.

At 614, process 600 may involve processor 512 transmitting a report to the wireless network.

In some implementations, in performing the wireless communications, process 600 may involve processor 512 receiving an SSB (e.g., a SS/PBCH block) configuration or an enhanced signaling that allows decoding of a PBCH by the at least one RedCap UE without RF retuning between multiple attempts. In some implementations, cell-level configurations may be restricted to SCS = 15 kHz for SSB, CORESET #0, and SIB1. In some implementations, an initial DL BWP configuration indicated for RedCap UEs, but not for non-RedCap UEs, by a SIB may be applied during a RACH procedure and onwards. Alternatively, or additionally, the initial DL BWP configuration indicated for RedCap UEs, but not for non-RedCap UEs, by the SIB may be applied after the initial access procedure.

In some implementations, in performing the wireless communications, process 600 may involve processor 512 receiving an SSB with a SCS = 30 kHz. In some implementations, the SSB may include a predetermined number (n) of OFDM symbols occupying multiple central PRBs being appended or prepended to a legacy SSB. In some implementations, n = 2, and in such cases the OFDM symbols may be appended after the legacy SSB. In some implementations, n ≥ 2, and in such cases the OFDM symbols may be appended or prepended to the legacy SSB depending on a position of the legacy SSB within a SSB burst structure.

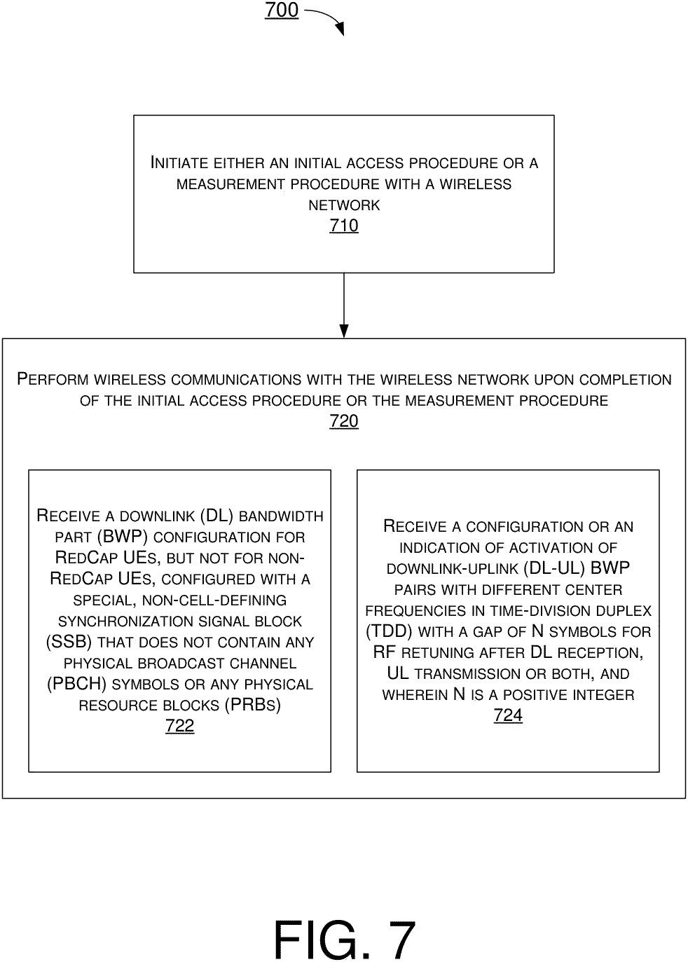

FIG. 7 illustrates an example process 700 in accordance with an implementation of the present disclosure. Process 700 may represent an aspect of implementing various proposed designs, concepts, schemes, systems and methods described above, whether partially or entirely, including those pertaining to those described above. More specifically, process 700 may represent an aspect of the proposed concepts and schemes pertaining to enhancements for coexistence with RedCap UEs with a restricted RF bandwidth plus measurements and synchronization in separate BWPs in mobile communications. Process 700 may include one or more operations, actions, or functions as illustrated by one or more of blocks 710 and 720 as well as subblocks 722 and 724. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in apparatus 510 and apparatus 520 as well as any variations thereof. Solely for illustrative purposes and without limiting the scope, process 700 is described below in the context of apparatus 510 as a UE (e.g., UE 110) and apparatus 520 as a communication entity such as a network node or base station (e.g., network node 125) of a wireless network (e.g., wireless network 120). Process 700 may begin at block 710.

At 710, process 700 may involve processor 512 of apparatus 510 initiating, via transceiver 516, either an initial access procedure or a measurement procedure with a wireless network (e.g., a cell associated with apparatus 520 as network node 125 of wireless network 120). The measurement procedure may involve processor 512 reporting to a serving cell of the wireless network about an outcome of one or more measurements performed on synchronization signals from both the service cell and a neighboring cell. Process 700 may proceed from 710 to 720.

At 720, process 700 may involve processor 512 performing, via transceiver 516, wireless communications with the wireless network upon completion of the initial access procedure or the measurement procedure. The wireless communications may be represented by 722 and/or 724.

At 722, process 700 may involve processor 512 receiving a DL BWP configuration for RedCap UEs, but not for non-RedCap UEs, configured with a special, non-cell-defining SSB that does not contain any PBCH.

At 724, process 700 may involve processor 512 receiving a configuration or an indication of activation of DL-UL BWP pairs with different center frequencies in TDD with a gap of N symbols for RF retuning after DL reception, UL transmission or both, with N being a positive integer.

In some implementations, the DL BWP configuration may be indicated via an SIB and may also be configured with a CSS associated with a RACH and with another CSS associated with paging.

In some implementations, the DL BWP configuration may be configured with a CSS associated with a RACH and with another CSS associated with paging. In some implementations, in addition to receiving the DL BWP configuration, process 700 may involve processor 512 performing additional operations. For instance, process 700 may involve processor 512 receiving a single SSS symbol or two SSS symbols back-to-back. Alternatively, process 700 may involve processor 512 receiving one PSS symbol and one or two SSS symbols back-to-back.

In some implementations, responsive to receiving the indication of activation of the DL-UL BWP pairs, either: (i) UE processing timelines may be extended by a duration of the gap; or (ii) the UE processing timelines may overlap with the duration of the gap, with a minimum between a duration of the UE processing timelines and the duration of the gap being taken as an effective gap for the RF retuning. In some implementations, responsive to receiving the configuration of the DL-UL BWP pairs, a configuration of SRS measurements falling outside of a UL BWP of the at least one RedCap UE is supported at least in TDD.

FIG. 8 illustrates an example process 800 in accordance with an implementation of the present disclosure. Process 800 may represent an aspect of implementing various proposed designs, concepts, schemes, systems and methods described above, whether partially or entirely, including those pertaining to those described above. More specifically, process 800 may represent an aspect of the proposed concepts and schemes pertaining to enhancements for coexistence with RedCap UEs with a restricted RF bandwidth plus measurements and synchronization in separate BWPs in mobile communications. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. Furthermore, one or more of the blocks/sub-blocks of process 800 may be executed iteratively. Process 800 may be implemented by or in apparatus 510 and apparatus 520 as well as any variations thereof. Solely for illustrative purposes and without limiting the scope, process 800 is described below in the context of apparatus 510 as a UE (e.g., UE 110) and apparatus 520 as a communication entity such as a network node or base station (e.g., network node 125) of a wireless network (e.g., wireless network 120). Process 800 may begin at block 810.

At 810, process 800 may involve processor 512 of apparatus 510 initiating, via transceiver 516, either an initial access procedure or a measurement procedure with a wireless network (e.g., a cell associated with apparatus 520 as network node 125 of wireless network 120). The measurement procedure may involve processor 512 reporting to a serving cell of the wireless network about an outcome of one or more measurements performed on synchronization signals from both the service cell and a neighboring cell. Process 800 may proceed from 810 to 820.

At 820, process 800 may involve processor 512 performing, via transceiver 516, wireless communications with the wireless network upon completion of the initial access procedure or the measurement procedure. In some implementations, frequency hopping of a BWP center frequency may be supported. Moreover, RRM report format options may include separate measurements for each BWP center frequency index.

In some implementations, frequency hopping of a BWP center frequency may be supported. In such cases, RRM report format options may include separate measurements for each BWP center frequency index. In some implementations, for each measurement object, an attribute may select a DL BWP center frequency index for which the measurement object is configured. In some implementations, the attribute may include a bitmap with each bit of the bitmap corresponding to a respective frequency hop, with a first value of each bit (e.g., 1) representing the measurement object being enabled and a second value of each bit (e.g., 0) representing the measurement object being disabled.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
initiating either an initial access procedure or a master information block (MIB)-decoding procedure with a wireless network; and
performing wireless communications with the wireless network upon completion of the initial access procedure or the MIB-decoding procedure,
wherein each of the initial access procedure and the MIB-decoding procedure involves performing one or more operations enhancing coexistence of at least one reduced-capability (RedCap) user equipment (UE) having a restricted radio frequency (RF) bandwidth with at least one non-RedCap UE,
wherein the MIB-decoding procedure involves receiving an MIB during paging or system information reception, and
wherein the one or more operations comprise either or both of:
receiving signaling from the wireless network; and
transmitting a report to the wireless network.

2. The method of claim 1, wherein the wireless communications involve receiving a synchronization signal block (SSB) configuration or an enhanced signaling that allows decoding of a physical broadcast channel (PBCH) by the at least one RedCap UE without RF retuning between multiple attempts.

3. The method of claim 2, wherein cell-level configurations are restricted to subcarrier spacing (SCS) = 15 kHz for SSB, control resource set (CORESET) #0, and system information block 1 (SIB1).

4. The method of claim 3, wherein an initial downlink (DL) bandwidth part (BWP) configuration indicated for RedCap UEs, but not for non-RedCap UEs, by a SIB is applied either during a random access channel (RACH) procedure and onwards or after the initial access procedure.

5. The method of claim 1, wherein the wireless communications involve receiving a synchronization signal block (SSB) with a subcarrier spacing (SCS) = 30 kHz, wherein the SSB comprises a predetermined number (n) of orthogonal frequency-divisional multiplexing (OFDM) symbols occupying multiple central physical resource blocks (PRBs) being appended or prepended to a legacy SSB.

6. The method of claim 5, wherein n = 2, and wherein the OFDM symbols are appended after the legacy SSB.

7. The method of claim 5, wherein n ≥ 2, and wherein the OFDM symbols are appended or prepended to the legacy SSB depending on a position of the legacy SSB within a SSB burst structure.

8. A method, comprising:
initiating either an initial access procedure or a measurement procedure with a wireless network; and
performing wireless communications with the wireless network upon completion of the initial access procedure or the measurement procedure,
wherein the measurement procedure involves reporting to a serving cell of the wireless network about an outcome of one or more measurements performed on synchronization signals from both the service cell and a neighboring cell, and
wherein the wireless communications involve:
receiving a downlink (DL) bandwidth part (BWP) configuration for RedCap UEs, but not for non-RedCap UEs, configured with a special, non-cell-defining synchronization signal block (SSB) that does not contain any physical broadcast channel (PBCH); or
receiving a configuration or an indication of activation of downlink-uplink (DL-UL) BWP pairs with different center frequencies in time-division duplex (TDD) with a gap of N symbols for RF retuning after DL reception, UL transmission or both, with N being a positive integer.

9. The method of claim 8, wherein the DL BWP configuration is indicated via a system information block (SIB) and is configured with a common search space (CSS) associated with a random access channel (RACH) and with another CSS associated with paging.

10. The method of claim 8, wherein the DL BWP configuration is configured with a common search space (CSS) associated with a random access channel (RACH) and with another CSS associated with paging.

11. The method of claim 8, wherein, in addition to receiving the DL BWP configuration, the one or more operations further comprise:
receiving a single secondary synchronization signal (SSS) symbol or two SSS symbols back-to-back; or
receiving one primary synchronization signal (PSS) symbol and one or two SSS symbols back-to-back.

12. The method of claim 8, wherein, responsive to receiving the indication of activation of the DL-UL BWP pairs, either:
UE processing timelines are extended by a duration of the gap; or
the UE processing timelines overlap with the duration of the gap, with a minimum between a duration of the UE processing timelines and the duration of the gap being taken as an effective gap for the RF retuning.

13. The method of claim 8, wherein, responsive to receiving the configuration of the DL-UL BWP pairs, a configuration of sounding reference signal (SRS) measurements falling outside of a UL BWP of the at least one RedCap UE is supported at least in time-division duplex (TDD).

14. A method, comprising:
initiating either an initial access procedure or a measurement procedure with a wireless network; and
performing wireless communications with the wireless network upon completion of the initial access procedure or the measurement procedure,
wherein the measurement procedure involves reporting to a serving cell of the wireless network about an outcome of one or more measurements performed on synchronization signals from both the service cell and a neighboring cell,
wherein frequency hopping of a bandwidth part (BWP) center frequency is supported, and
wherein radio resource management (RRM) report format options include separate measurements for each BWP center frequency index.

15. The method of claim 14, wherein, for each measurement object, an attribute selects a downlink (DL) BWP center frequency index for which the measurement object is configured.

16. The method of claim 15, wherein the attribute comprises a bitmap with each bit of the bitmap corresponding to a respective frequency hop, with a first value of each bit representing the measurement object being enabled and a second value of each bit representing the measurement object being disabled.

17. An apparatus, comprising:
a transceiver configured to communicate wirelessly; and
a processor coupled to the transceiver and configured to perform operations comprising:
initiating, via the transceiver, any of an initial access procedure, a master information block (MIB)-decoding procedure or a measurement procedure with a wireless network; and
performing, via the transceiver, wireless communications with the wireless network upon completion of the initial access procedure, the MIB-decoding procedure or the measurement procedure,
wherein the MIB-decoding procedure involves receiving an MIB during paging or system information reception, and
wherein the measurement procedure involves reporting to a serving cell of the wireless network about an outcome of one or more measurements performed on synchronization signals from both the service cell and a neighboring cell.

18. The apparatus of claim 17, wherein each of the initial access procedure and the MIB-decoding procedure involves performing one or more operations enhancing coexistence of at least one reduced-capability (RedCap) user equipment (UE) having a restricted radio frequency (RF) bandwidth with at least one non-RedCap UE, and wherein the one or more operations comprise either or both of:
receiving signaling from the wireless network; and
transmitting a report to the wireless network.

19. The apparatus of claim 17, wherein the wireless communications involve:
receiving a first downlink (DL) bandwidth part (BWP) configuration for RedCap UEs, but not for non-RedCap UEs, configured with a special, non-cell-defining synchronization signal block (SSB) that does not contain any physical broadcast channel (PBCH) symbols or any physical resource blocks (PRBs); or
receiving a second DL BWP configuration for the RedCap UEs, but not for the non-RedCap UEs, configured with a special, non-cell-defining synchronization signal block (SSB) that does not contain any physical broadcast channel (PBCH); or
receiving a configuration of downlink-uplink (DL-UL) bandwidth part (BWP) pairs with different center frequencies in time-division duplex (TDD) with a gap of N symbols for RF retuning after DL reception, UL transmission or both, with N being a positive integer.

20. The apparatus of claim 17, wherein frequency hopping of a bandwidth part (BWP) center frequency is supported, and wherein radio resource management (RRM) report format options include separate measurements for each BWP center frequency index.
